(19) United States
(12) Patent Application Publication
(10) Pub. No.: US 2025/0259574 A1
(43) Pub. Date: Aug. 14, 2025

(54) Functional trail marking system for the dark

(71) Applicant: Christina l. Sias, Nicholson, NC (US)

(72) Inventor: Christina l. Sias, Nicholson, NC (US)

(21) Appl. No.: 19/053,869

(22) Filed: Feb. 14, 2025

Related U.S. Application Data
(60) Provisional application No. 63/553,370, filed on Feb. 14, 2024.

(51) Int. Cl. G09F 13/20

(52) U.S. Cl. CPC G09F 13/20

(57) ABSTRACT

Apparatus and associated methods relate to a system for designing an ornamental path that includes at least one photoluminescent object along a predetermined path, the at least one photoluminescent object made from a mixture of resin and photoluminescent powder, and the at least one photoluminescent object operably coupled to a support structure. The photoluminescent object may, for example, include a coupling region. The coupling region may, for example, operably couple the photoluminescent object to the support structure. The support structure may advantageously enable the photoluminescent object to be placed along a path. Various embodiments may advantageously enable the system for designing an ornamental path to design and illuminate an ornamental path for a long period of time. The period may, for example, last from sunset to sunrise.

### CROSS-REFERENCE TO RELATED APPLICATIONS

This application is a non-provisional application and claims the benefit of U.S. Application Ser. No. 63/553,370, titled “Photoluminescent Trail Markers,” filed by Christina L. Sias on Feb. 14, 2024.

### TECHNICAL FIELD

Various embodiments relate generally to trail and/or path markers.

### BACKGROUND

Physical paths are meticulously planned, structured routes created to facilitate movement. Composed of materials like concrete, asphalt, gravel, or natural surfaces, these designated pathways adhere to specific dimensions, ensuring efficient pedestrian or vehicular traffic. Surface texture is tailored to intended use and environmental factors, considering accessibility and safety. In urban settings, paths form interconnected networks, enhancing transportation between areas. The planning encompasses material selection, dimensions, and environmental factors, resulting in enduring, functional infrastructure.

Photo luminescence is the absorption and gradual release of light energy as visible light. Photo luminescent materials, also known as phosphorescent or glow-in-the-dark materials, typically contain phosphors that absorb and emit light over time. This property is especially valuable in spaces where sudden power loss could occur. Photo luminescent materials also contribute to decorative and artistic applications, creating unique effects in the absence of external light sources.

Trail markers are vital elements along paths, providing guidance and information to outdoor enthusiasts. Strategically placed at key points, these markers come in various forms, such as painted symbols, signposts, or colored objects. Signs serve multiple purposes, indicating direction at trail junctions, marking distances, and signaling potential hazards. Colors and symbols are standardized for consistency across trails.

### SUMMARY

Apparatus and associated methods relate to a system for designing an ornamental path that includes at least one photoluminescent object along a predetermined path, the at least one photoluminescent object made from a mixture of resin and photoluminescent powder, and the at least one photoluminescent object operably coupled to a support structure. The photoluminescent object may, for example, include a coupling region. The coupling region may, for example, operably couple the photoluminescent object to the support structure. The support structure may advantageously enable the photoluminescent object to be placed along a path. Various embodiments may advantageously enable the system for designing an ornamental path to design and illuminate an ornamental path for a long period of time. The period may, for example, last from sunset to the sunrise.

Various embodiments may achieve one or more advantages. For example, some embodiments may advantageously enable the system for designing an ornamental path to be durable. Some embodiments may, for example, advantageously enable the system for designing an ornamental path to endure harsh weather conditions. Some embodiments may, for example, advantageously enable the system for designing an ornamental path to make a path more aesthetically pleasing. Some embodiments may, for example, advantageously enable a user of the system for designing an ornamental path to customize the ornamental style of the ornamental path. Some embodiments may, for example, advantageously enable the system for designing an ornamental path to make a dark path safer by illuminating the dark path.

The details of various embodiments are set forth in the accompanying drawings and the description below. Other features and advantages will be apparent from the description and drawings, and from the claims.

### BRIEF DESCRIPTION OF THE DRAWINGS

FIG. 1 depicts an exemplary system for designing an ornamental path employed in an illustrative use-case scenario.

FIG. 2 depicts an exemplary illustration of a photoluminescent object glowing in the dark.

FIG. 3 depicts an exemplary method of fabrication of a system for designing an ornamental path.

FIG. 4A depicts an exemplary embodiment of an ornamental design of a photoluminescent lion.

FIG. 4B depicts an exemplary embodiment of an ornamental design of a photoluminescent mushroom.

FIG. 5A depicts an exemplary embodiment of an ornamental design of a photoluminescent crescent wolf hanging with feathers.

FIG. 5B depicts an exemplary embodiment of an ornamental design of a photoluminescent spherical object.

FIG. 6A depicts an exemplary embodiment of an ornamental design of a photoluminescent pineapple.

FIG. 6B depicts an exemplary embodiment of an ornamental design of a photoluminescent statue.

FIG. 7A depicts an exemplary embodiment of an ornamental design of a photoluminescent seashell.

FIG. 7B depicts an exemplary embodiment of an ornamental design of a photoluminescent dog.

Like reference symbols in the various drawings indicate like elements.

### DETAILED DESCRIPTION OF ILLUSTRATIVE EMBODIMENTS

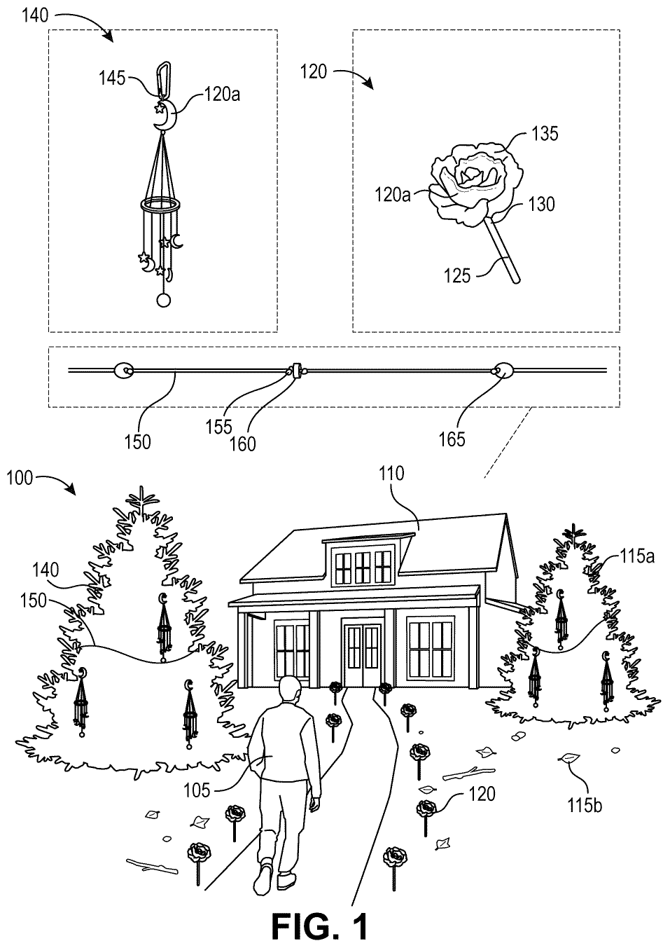

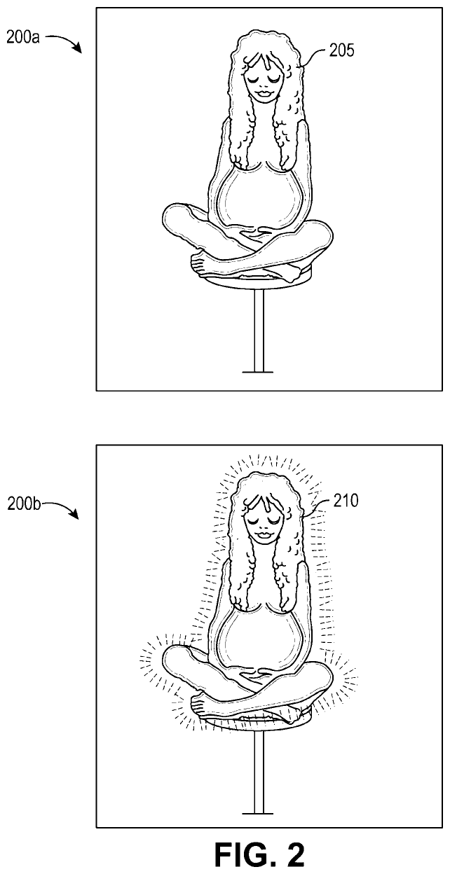

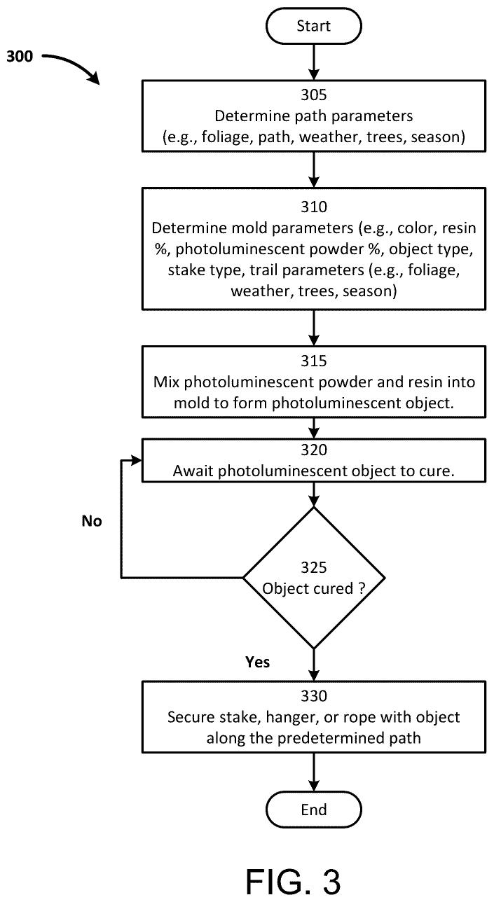

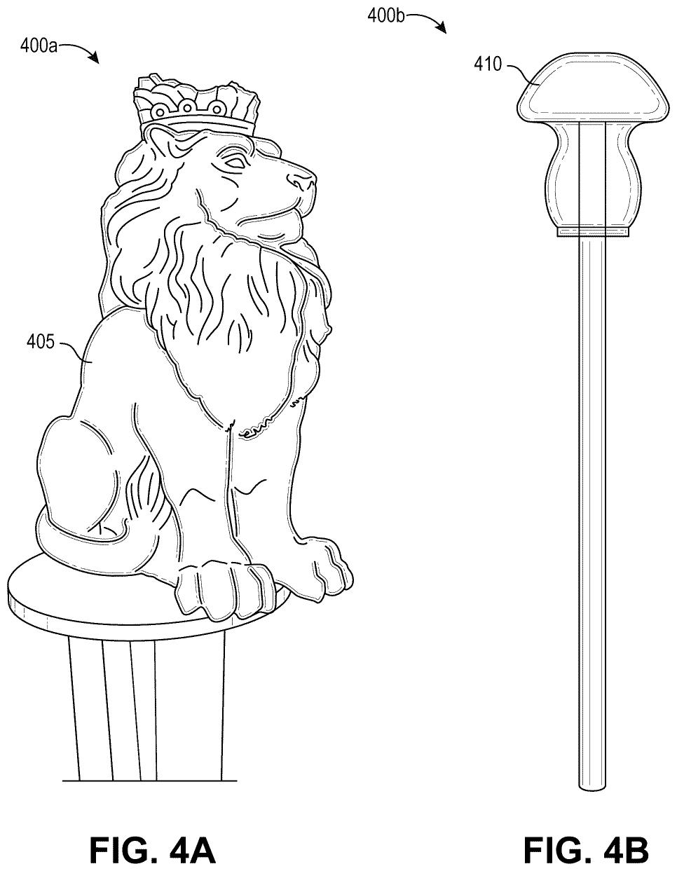

To aid understanding, this document is organized as follows. First, to help introduce discussion of various embodiments, a system for designing an ornamental path is introduced with reference to FIGS. 1-2. Second, that introduction leads to a description of an exemplary method of fabrication of a system for designing an ornamental path in FIG. 3. Finally, there is a description with reference to FIGS. 4A-7B of some exemplary embodiments of ornamental designs of a photoluminescent object.

FIG. 1 depicts an exemplary system for designing an ornamental path 100 employed in an illustrative use-case scenario. The illustrative use-case scenario 100 includes a user 105. The user 105 owns a home 110. The home 110 includes a path 115. The path 115 includes trees 115a. The path includes nature elements 115b. The nature elements 115b may, for example, include snow, fallen leaves, and foliage. When it is dark, the user 105 may, as depicted, walk on the path 115, not see the nature elements 115b, and get injured by bumping into the nature elements 115b. Along the path 115, are placed photoluminescent path markers such as those depicted in 120 and 140. The photoluminescent path markers 120 include a photoluminescent object 120a. The photoluminescent object 120a includes a coupling region 130. The coupling region 130 is a region where the photoluminescent object 120a operably couples a support structure, such as the support structures depicted in 125, 145 and 150. The support structure may include a stake 125. The stake 125 may releasably couple the photoluminescent object 120a. Once operably coupled to the photoluminescent object 120a, the stake 125 is placed into the ground at a predetermined height such that the photoluminescent object 120a is above the nature elements 115b. The support structure may include a hanger 145, as depicted. The photoluminescent object 120a operably couples a hanger 145 via the coupling region 130 of the photoluminescent object 120a. The hanger 145 may releasably couple the photoluminescent object 120a. The hanger 145 may advantageously enable the photoluminescent object 120a to hang on the branches of trees 115a. The placement of the photoluminescent objects 120a along the path 115 may advantageously enable a user 105 to illuminate and design an ornamental path 115.

The support structure may, for example, include a rope 150. The rope 150 may, for example, operably couple a photoluminescent object 165. The photoluminescent object 165 may, for example, include holes such that the photoluminescent object 165 may thread through the rope 150. The rope 150 may, for example, include a series of sets of adjacent beads 155. The rope may, for example, include a series of sets of adjacent knots 160. The photoluminescent object 165 may be positioned between a set of adjacent knots 155 and beads 160 such that the photoluminescent object 165 remains locked in a position on the rope 150.

The rope 150 may, for example, suspend from a tree 115a. The rope may, for example, lay along the edges of the path to outline the path. The rope 150 may, for example, drape over arches or trellises that span the width of the ornamental path 115. The rope 150 may advantageously enable the system for designing an ornamental path to adjust easily to fit paths of various lengths and curvatures. The rope 150 may advantageously enable the system for designing an ornamental path to be lightweight. The rope 150 may advantageously enable the system for designing an ornamental path to be easily coiled and stored for future use.

FIG. 2 depicts an exemplary illustration of a photoluminescent object glowing in the dark. As depicted in 200A, the photoluminescent object 205 is not glowing in the light. As depicted in 200B, the photoluminescent object 210 is glowing in the dark. The photoluminescent objects 205 and 210 may, for example, be made from a mixture of resin and photoluminescent powder. The photoluminescent powder may, for example, provide the photoluminescent object 210 with the ability to glow. The photoluminescent powder may include strontium aluminate doped with europium and dysprosium, for example. The strontium aluminate doped with europium and dysprosium may, for example, advantageously enable the photoluminescent object 210 to glow through phosphorescence. The strontium aluminate doped with europium and dysprosium may, for example, advantageously enable the photoluminescent object 210 to glow after exposure to a light source (e.g. UV light, sunlight, or artificial light).

In some implementations, the mixture of resin and photoluminescent powder may, for example, form a thermoset. The thermoset may advantageously enable the photoluminescent object to be durable. The thermoset may advantageously enable the photoluminescent object to endure harsh weather conditions.

By way of example, and not limitation, the mixture of resin and photoluminescent powder may, for example, include a ratio of 20%-33% photoluminescent powder and 80%-67% resin. By way of example, and not limitation, the mixture of resin and photoluminescent powder may, for example, be made of 2 ounces of resin and 0.4 ounces of photoluminescent powder. The % of photoluminescent powder, and the % of resin determine the number of lumens (e.g., brightness) emitted from a photoluminescent object and/or the length of time a photoluminescent object glows. The mixture of resin and photoluminescent powder may, for example, advantageously enable the photoluminescent object to glow for long periods of time. The long period of time may, for example, last from sunset till. The mixture of resin and photoluminescent powder may, for example, advantageously enable the photoluminescent object to be ecofriendly.

FIG. 3 depicts an exemplary method 300 of fabrication of an exemplary system for designing an ornamental path. A user may, for example, use the exemplary method 300 to fabricate an ornamental path. In step 305, a user determines the path parameters. The path parameters may, for example, include the foliage type (e.g., bushes, sticks, leaves), weather (climate for trail, rainy, sunny, dry, humid), season (winter, fall, spring, and/or summer).

In step 310, a user determines the mold parameters. The mold parameters may, for example, be based on the path parameters determined in step 305. The mold parameters may, for example, include color, resin %, photoluminescent %, object type, take type, path parameters. A user may, for example, create the mold to be more water resistant in wet climates. A user may, for example, create the mold to stand out in comparison to elements of the path. Paths may, for example, be created such that they do not need routine care and are long lasting. A user may, for example, craft the photoluminescent object to be 25% photoluminescent powder and 75% resin. A user may, for example, craft the photoluminescent object to be 33% photoluminescent powder and 67% resin. A user may, for example, craft the photoluminescent object to be 20% photoluminescent powder and 80% resin.

In step 315, a user may, for example, mix the photoluminescent powder and resin into a mold. In step 320, a user awaits the photoluminescent object to cure. The curing time may, for example, include an hour. The curing time may, for example, include 6 hours. The curing time may, for example, include 12 hours. Some embodiments may, for example, introduce a quick curing embodiment that cures within a shorter period.

In step 325, a user may, for example, determine whether the mold has cured and proceed to step 330. In step 325, a user may, for example, determine the mold has not cured and await the photoluminescent objects to be cured.

In step 330, a user secures the photoluminescent object to a stake, hanger, or rope along the predetermined path. In some embodiments, the stake, hanger, or rope may be cured onto the mold. In some embodiments the stake, hanger, or rope may, for example, be separate from the photoluminescent object. In some embodiments, a user may, for example, change out different photoluminescent objects onto the stake, hanger, or rope.

FIG. 4A depicts an exemplary embodiment of an ornamental design of a photoluminescent lion 400A. The photoluminescent lion 400A includes a photoluminescent object 405. The photoluminescent lion may, for example, operably a stake, as depicted. The photoluminescent lion 400A may, for example, couple a hanger. The photoluminescent lion 400A may, for example couple a rope. The photoluminescent lion 400A may, for example, be positioned along a garden. The photoluminescent lion 400A may, for example, be positioned along a trail. The photoluminescent lion 400A may, for example, be positioned along a road. The photoluminescent lion 400A may, for example, be positioned along a driveway.

FIG. 4B depicts an exemplary embodiment of an ornamental design of a photoluminescent mushroom 400B. The photoluminescent mushroom 400B includes a photoluminescent object 410. The photoluminescent mushroom 400B may, for example, operably a stake, as depicted. The photoluminescent mushroom 400B may, for example, couple a hanger. The photoluminescent mushroom 400B may, for example couple a rope. The photoluminescent mushroom 400B may, for example, be positioned along a garden. The photoluminescent mushroom 400B may, for example, be positioned along a trail. The photoluminescent mushroom 400B may, for example, be positioned along a road. The photoluminescent mushroom 400B may, for example, be positioned along a driveway.

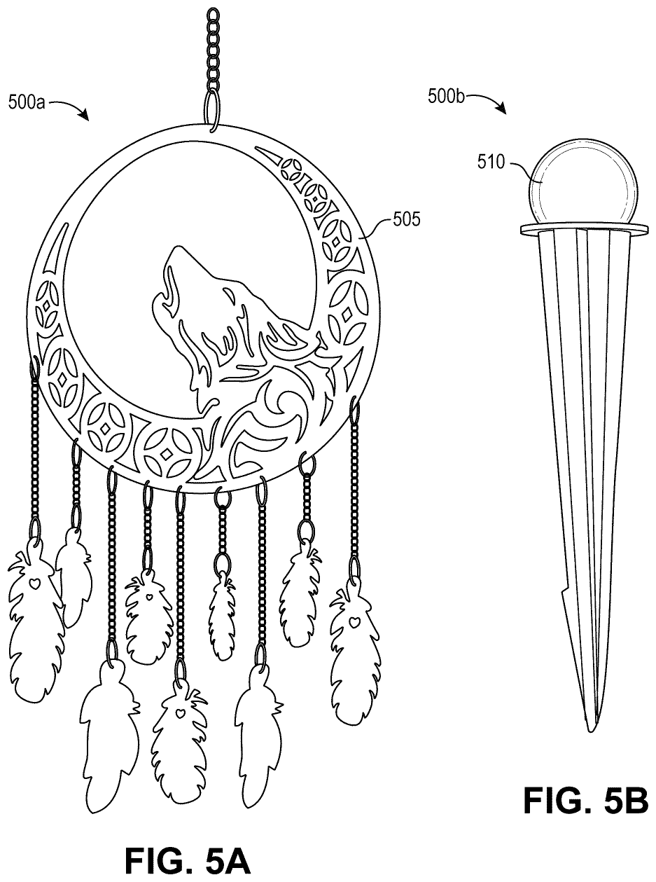

FIG. 5A depicts an exemplary embodiment of an ornamental design of a photoluminescent crescent wolf hanging with feathers 500A. The photoluminescent crescent wolf hanging with feathers 500A includes a photoluminescent object 505. The photoluminescent crescent wolf hanging with feathers 500A may, for example, operably a stake. The photoluminescent crescent wolf hanging with feathers 500A may, for example, couple a hanger, as depicted. The photoluminescent crescent wolf hanging with feathers 500A may, for example couple a rope. The photoluminescent crescent wolf hanging with feathers 500A may, for example, be positioned along a garden. The photoluminescent crescent wolf hanging with feathers 500A may, for example, be positioned along a trail. The photoluminescent crescent wolf hanging with feathers 500A may, for example, be positioned along a road. The photoluminescent crescent wolf hanging with feathers 500A may, for example, be positioned along a driveway.

FIG. 5B depicts an exemplary embodiment of an ornamental design of a photoluminescent spherical object 500B. The photoluminescent spherical object 500B includes a photoluminescent object 510. The photoluminescent spherical object 500B may, for example, operably a stake, as depicted. The photoluminescent spherical object 500B may, for example, couple a hanger. The photoluminescent spherical object 500B may, for example couple a rope. The photoluminescent spherical object 500B may, for example, be positioned along a garden. The photoluminescent spherical object 500B may, for example, be positioned along a trail. The photoluminescent spherical object 500B may, for example, be positioned along a road. The photoluminescent spherical object 500B may, for example, be positioned along a driveway.

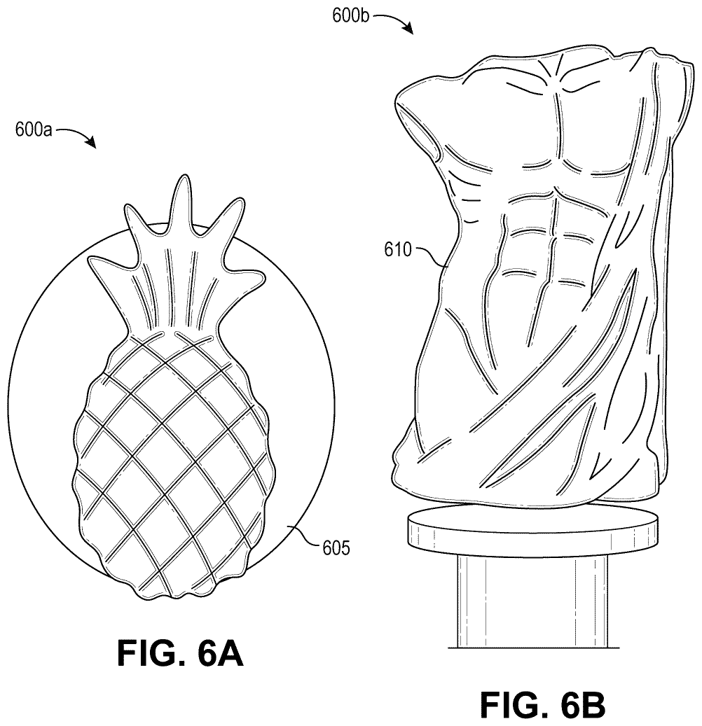

FIG. 6A depicts an exemplary embodiment of an ornamental design of a photoluminescent pineapple 600A. The photoluminescent pineapple 600A includes a photoluminescent object 605. The photoluminescent pineapple 600A may, for example, operably a stake, as depicted. The photoluminescent pineapple 600A may, for example, couple a hanger. The photoluminescent pineapple 600A may, for example couple a rope. The photoluminescent pineapple 600A may, for example, be positioned along a garden. The photoluminescent pineapple 600A may, for example, be positioned along a trail. The photoluminescent pineapple 600A may, for example, be positioned along a road. The photoluminescent pineapple 600A may, for example, be positioned along a driveway.

FIG. 6B depicts an exemplary embodiment of an ornamental design of a photoluminescent statue 600B. The photoluminescent statue 600B includes a photoluminescent object 610. The photoluminescent statue 600B may, for example, operably a stake, as depicted. The photoluminescent statue 600B may, for example, couple a hanger. The photoluminescent statue 600B may, for example couple a rope. The photoluminescent statue 600B may, for example, be positioned along a garden. The photoluminescent statue 600B may, for example, be positioned along a trail. The photoluminescent statue 600B may, for example, be positioned along a road. The photoluminescent statue 600B may, for example, be positioned along a driveway.

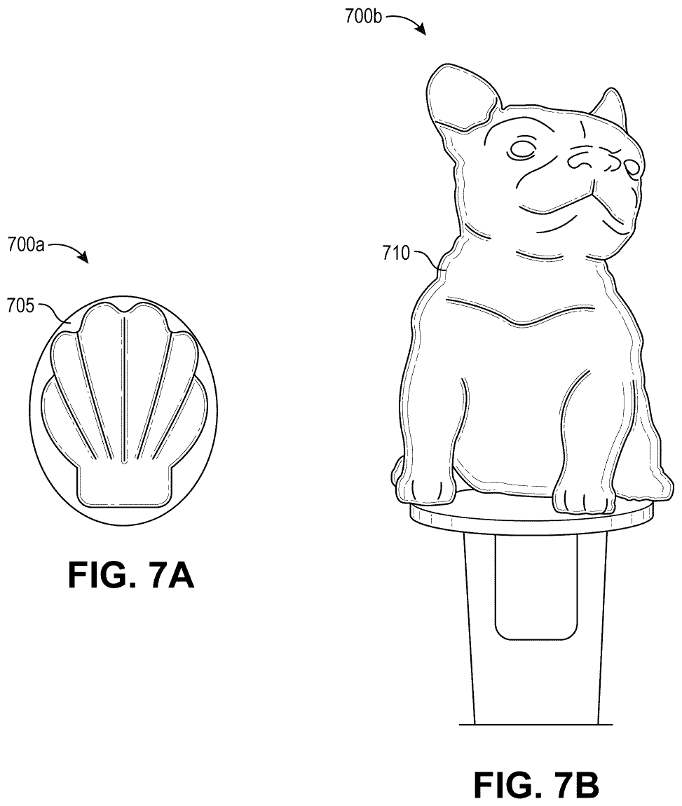

FIG. 7A depicts an exemplary embodiment of an ornamental design of a photoluminescent seashell 700A. The photoluminescent seashell 700A includes a photoluminescent object 705. The photoluminescent seashell 700A may, for example, operably a stake, as depicted. The photoluminescent seashell 700A may, for example, couple a hanger. The photoluminescent seashell 700A may, for example couple a rope. The photoluminescent seashell 700A may, for example, be positioned along a garden. The photoluminescent seashell 700A may, for example, be positioned along a trail. The photoluminescent seashell 700A may, for example, be positioned along a road. The photoluminescent seashell 700A may, for example, be positioned along a driveway.

FIG. 7B depicts an exemplary embodiment of an ornamental design of a photoluminescent dog 700B. The photoluminescent dog 700B includes a photoluminescent object 710. The photoluminescent dog 700B may, for example, operably a stake, as depicted. The photoluminescent dog 700B may, for example, couple a hanger. The photoluminescent dog 700B may, for example couple a rope. The photoluminescent dog 700B may, for example, be positioned along a garden. The photoluminescent dog 700B may, for example, be positioned along a trail. The photoluminescent dog 700B may, for example, be positioned along a road. The photoluminescent dog 700B may, for example, be positioned along a driveway.

In some embodiments, the photoluminescent 120a object may, for example, operably couple a stake 125. The stake 125 may, for example, be placed into the ground at a predetermined height. The stake 125 may, for example, include powder-coated aluminum stakes. The powder-coated aluminum stake may advantageously enable the stake 125 to be durable. The powder-coated aluminum stake may advantageously enable the stake 125 to maintain its original appearance for longer periods of time. The powder-coated aluminum stake may advantageously enable the stake 125 to be resistant to weather and environmental factors. The powder-coated aluminum stake 125 may advantageously enable the stake 125 to be eco-friendly. The powder-coated aluminum stake may advantageously enable the stake to not rust.

In some embodiments, the stake 125, may, for example include a coupling module. The coupling module may advantageously enable the stake 125 to couple the photoluminescent object 120a. irremovably. The coupling module may advantageously enable the stake 125 to releasably couple the photoluminescent object 120a. For example, the coupling module may include complimentary threads on both the stake 125 and photoluminescent object 120a, such that the photoluminescent object 120a may screw into the stake 125. The coupling module may, for example, include a snapping mechanism such that the photoluminescent object 120a snaps into the stake 125. The coupling module may, for example, include a sliding mechanism, such that the photoluminescent object 120a snaps into the stake 125.

In some embodiments, the stake 125, may, for example include a spring. The spring may, for example, advantageously enable the stake to remain in place if hit by something, for example, a car or animal.

In some embodiments, the photoluminescent 120a object may, for example, operably couple a hanger. The hanger 145 may releasably couple the photoluminescent object 120a. The hanger 145 may irremovably couple the photoluminescent object 120a. The hanger may, for example suspend from a tree 115a. The hanger 145 may, for example, suspend from a pole. The hanger 145 may, for example, suspend from a hooks lining. The hanger 145 may, for example suspend from an arch or trellis. The hanger 145 may, for example, suspend from a fence. The hanger 145 may, for example, suspend from a baby's crib. The hanger 145 may, for example, suspend from a house. The hanger 145 may advantageously enable the photoluminescent object 120a to hang from structures. The hanger 145 may advantageously enable the photoluminescent object 120a to avoid cluttering a path with objects. The hanger 145 may advantageously enable the photoluminescent object 120a to avoid being stepped on or damaged.

In an exemplary embodiment, a system for designing an ornamental path may include a garden as the path. The system for designing an ornamental path may advantageously enable a user to decorate a garden. The system for designing an ornamental path may advantageously enable a user to see and locate various plants within the garden through illuminating the garden.

In an exemplary embodiment, a system for designing an ornamental path may include a trail as the path. The photoluminescent object may, for example, act as trail markers. The trail markers may, for example, be determined to provide the optimal safety based on the marker color, trail path, object, and number of markers. Some trail markers may, for example, be operated in a system to facilitate safe parking in dark unlit areas for motor vehicles. The trail markers may, for example, be designed to operate in forest conditions. The trail markers may, for example, be designed to operate on hills. The trail markers may, for example, be used to mark different trail types (e.g., grass path, asphalt, gravel, rocky, slippery).

In an exemplary embodiment, a system for designing an ornamental path may include a road as a path. The photoluminescent object may, for example, illuminate road signs. The photoluminescent object may, for example, illuminate billboards.

In an exemplary embodiment, a system for designing an ornamental path may include a driveway as a path. The system for designing an ornamental path may, for example, be utilized as Christmas decorations (e.g., Santa clause, sleds, reindeer, etc.), Valentines Day decorations (e.g. heart, cupid, etc.), fall decorations (e.g., fallen leaves, turkeys, etc.), 4ₜₕ of July decorations (flags, stars, cannons, etc.). Different colors may, for example, be used for the photoluminescent objects in color coordination (e.g., red and green for Christmas; red, white, and blue for 4ₜₕ of July; pink for Valentines Day).

Although various embodiments have been described with reference to the figures, other embodiments are possible.

Although an exemplary system has been described with reference to FIG. 1-7, other implementations may be deployed in other industrial, scientific, medical, commercial, and/or residential applications. For example, the system may illuminate pathways in airports to guide passengers to gates, baggage claim, or exits. The system may, for example, delineate safe zones and guide workers or equipment in industrial settings.

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated within the scope of the following claims.

What is claimed is:

1. A system for designing an ornamental path comprising:
a plurality of photoluminescent path markers extending along a predetermined path, the path marker comprising:
at least one photoluminescent object made from a mixture of resin and photoluminescent powder, wherein the photoluminescent object is configured to emit light in the dark;
a coupling region on the photoluminescent object; and
at least one stake structure extending along a longitudinal direction comprising a corresponding stake coupling region at a top end of the stake structure configured to receive at least one photoluminescent object; and,
at least one corresponding hanging structure comprising a hanger comprising a corresponding coupling region operably coupled to the coupling region.

2. The system of claim 1, wherein at least one hanging structure comprises a photoluminescent rope system comprising:
a rope with two or more photoluminescent objects comprising holes to receive the rope;
and,
a series of sets of adjacent knots situated between adjacent sides of the rope extending along the path for the two or more threaded photoluminescent objects.

3. The system of claim 1, wherein the photoluminescent object includes a person.

4. The system of claim 1, wherein the photoluminescent object includes a mushroom.

5. The system of claim 1, wherein the photoluminescent object includes a bulb.

6. The system of claim 1, wherein the photoluminescent object includes a fruit.

7. The system of claim 1, wherein the photoluminescent object includes a shell.

8. The system of claim 1, wherein the photoluminescent object includes a statue.

9. The system of claim 1, wherein the photoluminescent object includes an animal.

10. The system of claim 1, wherein the mixture of resin and photoluminescent powder comprises 20%-33% photoluminescent powder and 80%-67% resin.

11. The system of claim 1, wherein the predetermined path extends along a trail.

12. The system of claim 1, wherein at least one photoluminescent object is removably coupled to the at least one stake structure.

13. The system of claim 1, wherein at least one photoluminescent object is removably coupled to at least one corresponding hanging structure.

14. A system for designing an ornamental path comprising:
a plurality of photoluminescent path markers extending along a predetermined path, the path marker comprising:
at least one photoluminescent object made from a mixture of resin and photoluminescent powder, wherein the photoluminescent object is configured to emit light in the dark from sunset till sunrise;
a coupling region on the photoluminescent object;
at least one stake structure extending along a longitudinal direction comprising a corresponding stake coupling region at a top end of the stake structure configured to receive at least one photoluminescent object; and,
at least one corresponding hanging structure comprising a hanger corresponding coupling region operably coupled to the coupling region.

15. The system of claim 14, wherein at least one hanging structure comprises a photoluminescent rope system comprising:
a rope with two or more photoluminescent objects comprising holes to receive the rope; and,
a series of sets of adjacent knots situated between adjacent sides of the rope extending along the path for the two or more threaded photoluminescent objects

16. The system of claim 15, wherein the mixture of resin and photoluminescent powder comprises 20%-33% photoluminescent powder and 80%-67% resin.

17. The system of claim 15, wherein the photoluminescent object is removably coupled to the at least one stake structure.

18. The system of claim 15, wherein at least one photoluminescent object is removably coupled to at least one corresponding hanging structure

19. The system of claim 15, wherein the predetermined path extends along a trail.

20. A method for designing an ornamental path, comprising:
determining path parameters, including foliage type, weather conditions, and season;
determining mold parameters based on the path parameters, including color, resin percentage, photoluminescent powder percentage, and object type;
mixing photoluminescent powder and resin into a mold according to the determined parameters;
allowing the mixture to cure for a predetermined period;
securing the cured photoluminescent object to a stake, hanger, or rope along the predetermined path; and,
placing the stake into the ground or suspending the hanger from a structure, such that the photoluminescent object is positioned to illuminate the path.
